(19) United States
(12) Patent Application Publication
(10) Pub. No.: US 2004/0207961 A1
(43) Pub. Date: Oct. 21, 2004

(54) MR (magnetoresistance) device and magnetic recording device

(76) Inventors: Masahiko Ichimura, Tokyo (JP); Tomihiro Hashizume, Tokyo (JP); Toshiyuki Onogi, Tokyo (JP); Kenchi Ito, Tokyo (JP); Hideyuki Matsuoka, Tokyo (JP)

Correspondence Address: REED SMITH LLP, Suite 1400, 3110 Fairview Park Drive, Falls Church, VA, 22042, US

(21) Appl. No.: 10/700,519

(22) Filed: Nov. 5, 2003

(30) Foreign Application Priority Data
Nov. 8, 2002 (JP) 2002-324874

(51) Int. Cl. G11B 5/39

(52) U.S. Cl. 360/324.2

(57) ABSTRACT

Disclosed is a magnetoresistance device which uses a ferromagnetic tunnel junction formed by inserting an insulating layer between two ferromagnetic layers and whose application to a magnetic head and a magnetoresistance memory is promising. The magnetoresistance device has a multilayer structure which has a ferromagnetic tunnel junction formed by lamination of a first ferromagnetic layer, an insulating layer and a second ferromagnetic layer, and in which at least one of the first and second ferromagnetic layers is a half-metallic ferromagnet formed of a material having such an electronic structure that one spin having a metallic band near Fermi energy has a gap at a level of higher energy than the Fermi energy and the other spin has a metallic band at the same level.

### FIELD OF THE INVENTION

The present invention relates to a magnetic device made of a half-metallic ferromagnet and having a function similar to that of the half-metallic ferromagnet even when applied with a finite voltage and an MR (Magnetoresistance) device, a spin injection device, a high-density magnetic writing and reading magnetic head and various kinds of magnetic sensors all of which use the magnetic device, a solid state memory device which writes information using spin injection and reads information using a MR effect, and a device using those devices.

### BACKGROUND OF THE INVENTION

The MR effect is a phenomenon in which the electric resistance changes when a magnetic field is applied to a magnet. MR devices which utilize this effect are used in magnetic heads, magnetic sensors and so forth, and have recently been embodied into a magnetic random access memory (MRAM) or the like experimentally. Those MR devices are demanded of a high MR ratio and a high sensitivity to an external magnetic field.

Recently, in a tunnel junction formed by inserting an insulating layer between two ferromagnetic layers, i.e., in a ferromagnetic tunnel junction, a MR device (tunnel magnetoresistance device (TMR)) which uses the tunneling current has been found. As the ferromagnetic tunnel junction has an MR ratio of over 20% (J. Appl. Phys. 79, 4724-4729 (1996)), the possibility of its application to a magnetic head and MR memory is increasing. While the MR ratio at room temperature is about 40%, a greater value of the MR ratio is desired to acquire necessary output voltage values. If the applied voltage is increased to acquire the necessary output voltages in the ferromagnetic tunnel junction, there arises a problem that the MR ratio decreases (Phys. Rev. Lett. 74, 3273-3276 (1995)).

There has been proposed to use a half-metallic ferromagnet for the ferromagnetic electrode in the ferromagnetic tunnel junction in order to increase the value of the MR ratio (Japanese Patent Laid-Open No. 135857/1999). However, no particular measures have been taken against the problem that an increase in applied voltage reduces the MR ratio (Appl. Phys. Lett. 73, 1008-1010 (1998)).

With regard to the problem that increasing the applied voltage lowers the MR ratio, there is a proposal for using double tunnel junction (Japanese Patent Laid-Open No. 2001-156357). While this proposal has an effect of suppressing a reduction in MR ratio, it does not demonstrate an effect of increasing the MR ratio itself when the applied voltage is zero because the ferromagnet which forms the double tunnel junction is a Co base alloy or Ni—Fe alloy.

In an MRAM which uses a ferromagnetic tunnel junction and writes information utilizing the parallel and antiparallel magnetization configuration, there is a leak current from memory cells, so that selection of memory cells by MOS transistors is essential. The structure in which a memory cell is paired with an MOS transistor provides about the same level of integration as the conventional DRAM and has a demerit of requiring a composite process technology.

In case where the ferromagnetic tunnel junction is adapted to MRAMs, the current is let to flow to wires to apply an external magnetic field (current-inducing field) to a ferromagnetic layer (free layer) the direction of whose magnetization is not fixed, thereby reversing the magnetization of the free layer. However, an increase in the magnetic field (switching field), needed for magnetization reversal of the free layer, which is accompanied with reduction in memory cells increases the wire current. Therefore, increasing the capacity of the MRAM inevitably increases the consumed power. The increase in wire current brings about a possible problem that the wires may be melted.

One way to cope with this problem is to reverse the magnetization by injecting the spin-polarized current (Phys. Rev. Lett. 84, 3149-3152 (2000) and Appl. Phys. Lett. 78, 3663-3665 (2001)). The injection of the spin-polarized current to reverse the magnetization however increases the current density that flows to the TMR devices, which may break down the tunnel insulating layer. No device structures that are suitable for spin injection have not been proposed yet.

### SUMMARY OF THE INVENTION

Accordingly, it is an object of the invention to provide a tunnel junction type MR device and magnetic recording device which increase the MR ratio itself when the applied voltage is zero and makes the MR ratio even under application of a finite voltage to about the same level as that of the case where the applied voltage is zero by using a half-metallic ferromagnet formed of a material having such an electronic structure that one spin having a metallic band near Fermi energy has a gap at a level of higher energy than the Fermi energy and the other spin has a metallic band at the same level.

It is another object of the invention to provide an MRAM which uses the MR devices as its memory cells so as to acquire a sufficient output signal even if there is a leak current from the memory cells, and thus requires no structure having pairs of memory cells and MOS transistors.

It is a further object of the invention to provide a method which ensure writing to a magnetic recording device by using the aforementioned MR device having a structure suitable for spin injection.

It is a still further object of the invention to provide an apparatus to which those devices mentioned above are adapted.

To achieve the objects, a MR device according to the invention can be realized by a multilayer structure which has a ferromagnetic tunnel junction formed by lamination of a first ferromagnetic layer, an insulating layer and a second ferromagnetic layer, or lamination of an antiferromagnetic layer, a first ferromagnetic layer, an insulating layer and a second ferromagnetic layer, and in which at least one of the first and second ferromagnetic layers is a half-metallic ferromagnet formed of a material having such an electronic structure that one spin having a metallic band near Fermi energy has a gap at a level of higher energy than the Fermi energy and the other spin has a metallic band at the same level.

A MR device according to the invention can be realized by a multilayer structure which has a ferromagnetic tunnel junction formed by lamination of a ferromagnetic layer, an insulating layer and a semiconductor layer, or a double layer structure which has a ferromagnetic tunnel junction formed by lamination of a ferromagnetic layer and a semiconductor layer, and in which the ferromagnetic layer is a half-metallic ferromagnet formed of a material having such an electronic structure that one spin having a metallic band near Fermi energy has a gap at a level of higher energy than the Fermi energy and the other spin has a metallic band at the same level.

A magnetic head according to the invention can be realized by applying a proper voltage and an external magnetic field to a multilayer structure which constitutes the MR device.

A solid state memory according to the invention can be realized by selectively allowing an external magnetic field corresponding to data to be written to act on one of an X-Y matrix of the MR devices to write data there and selectively reading the written data from one of the MR devices.

Another solid state memory according to the invention has, as memory devices; multilayer structures each having lamination of a nonmagnetic layer and a third ferromagnetic layer further laminated on the MR device and has the memory devices laid out in an X-Y matrix. Data is written by letting the tunnel current to flow to the first ferromagnetic layer-insulating layer-second ferromagnetic layer of the MR device of one of the X-Y matrix of memory devices. The written data is read out by the current that flows in the second ferromagnetic layer-nonmagnetic layer-third ferromagnetic layer.

### BRIEF DESCRIPTION OF THE DRAWINGS

FIG. 1 is a diagram showing the electronic structure of a ferromagnetic material which is used in an MR device and a spin injection type MR device according to the invention;

FIG. 2 is a diagram showing the cross-sectional structure of an MR device 20 according to the invention;

FIG. 3 is a diagram showing a modification of the MR device according to the invention;

FIG. 4 is a diagram showing the cross-sectional structure of a spin injection device according to the invention;

FIG. 5 is a diagram showing a modification of the spin injection device according to the invention;

FIG. 6 is a diagram showing the cross-sectional structure of a solid state memory according to the invention;

FIG. 7 is a diagram exemplarily illustrating a circuit structure to be adapted to a magnetic head or a magnetic sensor;

FIG. 8 is a diagram exemplarily showing the density of states of a first ferromagnetic layer 21, an insulating layer 22 and a second ferromagnetic layer 23 of an MR device 20 in case where the magnetizations of the first and second ferromagnetic layers are parallel to each other;

FIG. 9 is an exemplary diagram of the density of states corresponding to those in FIG. 8 in case where the magnetizations of the first and second ferromagnetic layers are antiparallel to each other;

FIG. 10 is a diagram showing a current vs. voltage characteristic obtained in case where the magnetizations of the first and second ferromagnetic layers are (a) parallel or (b) antiparallel to each other;

FIG. 11 is a diagram showing the density of states of Co;

FIG. 12 is a diagram showing the density of states corresponding to those in FIG. 8 in case where a Co base alloy is substituted for the second ferromagnetic layer 23;

FIG. 13 is a diagram showing the density of states corresponding to those in FIG. 9 in case where a Co base alloy is substituted for the second ferromagnetic layer 23;

FIG. 14 is a diagram showing a solid state memory in case where MR devices 20 shown in FIG. 2 are laid out in two rows by two columns as one example of the X-Y matrix;

FIG. 15 is a diagram for explaining how the magnetization of an MR device located at a position where currents flow to both a word line and a bit line is reversed (written by magnetization) by a magnetic field generated by the sum of both currents;

FIG. 16 is an exemplary diagram showing an example in which a solid state memory using MR devices shown in FIG. 2 is mounted on a silicon substrate for a single memory device 220;

FIG. 17 is a diagram showing a current vs. voltage characteristic of the memory 220 formed as shown in FIG. 16;

FIG. 18 is a diagram illustrating a solid state memory in case where MR devices 60 shown in FIG. 6 are laid out in two rows by two columns as one example of the X-Y matrix;

FIG. 19 is an exemplary diagram illustrating an example in which a solid state memory using MR devices shown in FIG. 6 is mounted on a silicon substrate for a single memory device 220;

FIG. 20 is a diagram showing a current vs. voltage characteristic between a second ferromagnetic layer MnC 23 and a third ferromagnetic layer Co 65 of the solid state memory shown in FIG. 19;

FIG. 21 is an exemplary diagram of the density of states of a memory device in case where the magnetizations of a first ferromagnetic layer MnC 21 and the second ferromagnetic layer MnC 23 of the solid state memory shown in FIG. 19 are antiparallel to each other;

FIG. 22 is an exemplary diagram of the density of states of a memory device in case where the magnetizations of the first ferromagnetic layer MnC 21 and the second ferromagnetic layer MnC 23 of the solid state memory shown in FIG. 19 are parallel to each other;

FIG. 23 is an exemplary diagram of the density of states in case where the spin injection device shown in FIG. 4 can inject only the down spin to a semiconductor layer 43;

FIG. 24 is an exemplary diagram of the density of states in case where the spin injection device shown in FIG. 4 can inject only the up spin to the semiconductor layer 43.

### DESCRIPTION OF THE PREFERRED EMBODIMENT

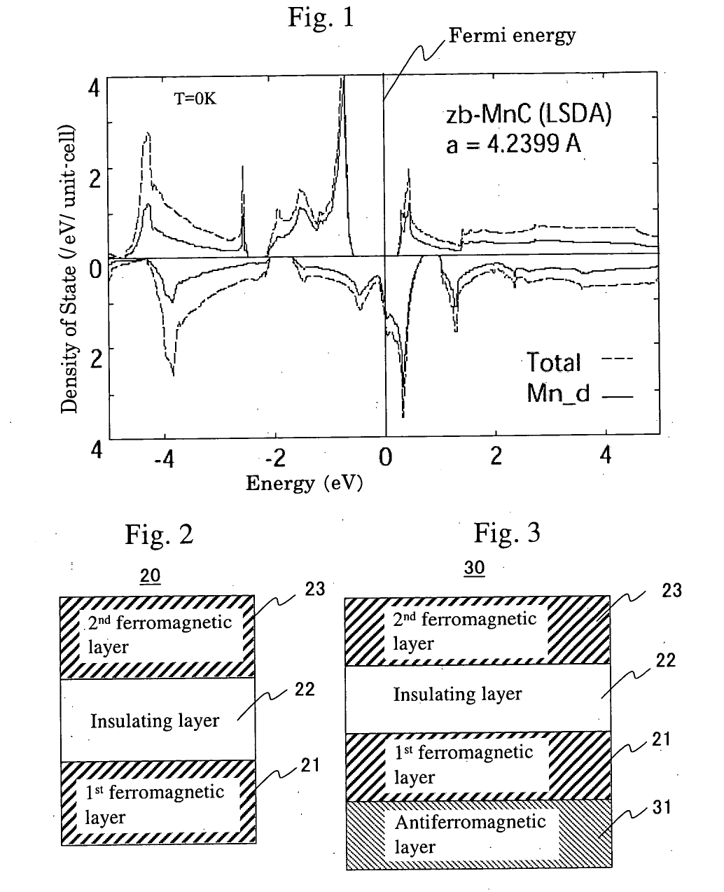

The fundamental structure of an MR device according to the invention will be described below with reference to FIGS. 1 to 3.

FIG. 1 is a diagram showing the electronic structure of a ferromagnetic material which is used in an MR device and a spin injection type MR device according to the invention, and shows the most stable electronic structure of the zinc-blende structure MnC obtained from the first-principle electronic structure calculation. FIG. 1 shows the results of calculation at 0 K (absolute temperature of 0).

In FIG. 1, the up-spin band has an energy gap near Fermi energy and the down-spin band is metallic near Fermi energy. A material which has such an electronic structure is called half-metallic ferromagnet. In FIG. 1, there is a gap in a down-spin state at an energy level higher than the Fermi energy by 1 eV in addition to the up-spin band gap which characterizes the half-metallic ferromagnet. The up-spin band with this energy is metallic. As the sizes of the up-spin and down-spin gaps are respectively 0.82 eV and 0.26 eV, only one spin contributes to electric conduction at room temperature. Depending on the applied voltage, only one of the up spin and down spin can be selected for conduction.

Although only the most stable electronic structure of the zinc-blende structure MnC is illustrated here, materials which show similar electronic structures can demonstrate the effects of the invention. As the ferromagnetic material to be used in the invention functions with respect to a material in which the up-spin and down-spin states in the most stable electronic structure of the zinc-blende structure MnC are reversed, the invention can apparently be adapted to this material.

FIG. 2 is a diagram showing the cross-sectional structure of an MR device 20 according to the invention. The MR device 20 has a tunnel junction formed by lamination of first ferromagnetic layer 21/insulating layer 22/second ferromagnetic layer 23. In this device 20, the tunnel current is let to flow between the first ferromagnetic layer 21 and the second ferromagnetic layer 23 via the insulating layer 22. In the device 20, the first ferromagnetic layer 21 is a pin layer (magnetization-fixed layer) and the second ferromagnetic layer 23 is a free layer (a recording layer in case of MRAM). In the first MR device, at least one of the first ferromagnetic layer 21 and the second ferromagnetic layer 23 is formed of a half-metallic ferromagnet which has the electronic structure of the ferromagnetic material as illustrated in FIG. 1. Although FIG. 2 shows the individual layers in the same thickness for the sake of convenience, actually, the insulating layer 22 is extremely thin as compared with the first ferromagnetic layer 21 and the second ferromagnetic layer 23. For the first ferromagnetic layer 21 to be a pin layer (magnetization-fixed layer), the first ferromagnetic layer 21 is made sufficiently thicker than the second ferromagnetic layer 23.

FIG. 3 is a diagram showing a modification of the MR device according to the invention. This MR device 30 takes a lamination structure such that an antiferromagnetic layer 31 is added in contact with the first ferromagnetic layer 21 in the lamination of first ferromagnetic layer 21/insulating layer 22/second ferromagnetic layer 23 shown in FIG. 2. In this device 30 like the MR device 20 shown in FIG. 2, the tunnel current is also let to flow between the first ferromagnetic layer 21 and the second ferromagnetic layer 23 via the insulating layer 22. In the device 30, the first ferromagnetic layer 21 is a pin layer (magnetization-fixed layer) and the second ferromagnetic layer 23 is a free layer (a recording layer in case of MRAM). The MR device 30 shown in FIG. 3 is characterized in that the magnetization direction of the first ferromagnetic layer 21 is fixed by exchange interaction with the antiferromagnetic layer 31 to make the pin layer stable. In the MR device 30, at least one of the first ferromagnetic layer 21 and the second ferromagnetic layer 23 is formed of a half-metallic ferromagnet which has the electronic structure of the ferromagnetic material as illustrated in FIG. 1.

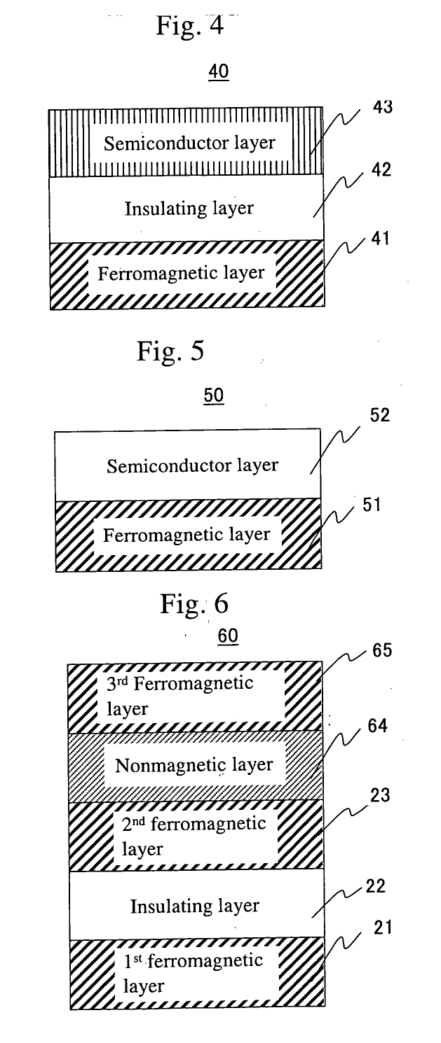

The fundamental structure of a spin injection device according to the invention will be discussed below referring to FIGS. 4 and 5.

FIG. 4 is a diagram showing the cross-sectional structure of the spin injection device according to the invention. This spin injection device 40 has a tunnel junction formed by lamination of ferromagnetic layer 41/insulating layer 42/semiconductor layer 43. In this device 40, the tunnel current is let to flow between the ferromagnetic layer 41 and the semiconductor layer 43 via the insulating layer 42 to thereby inject the spins of the ferromagnetic layer 41 into the semiconductor layer 43. In the spin injection type MR device 40, the ferromagnetic layer 41 is formed of a half-metallic ferromagnet which has the electronic structure of the ferromagnetic material as illustrated in FIG. 1.

FIG. 5 is a diagram showing the cross-sectional structure of a modification of the spin injection device according to the invention. This spin injection device 50 has a Shottky junction formed by lamination of ferromagnetic layer 51/semiconductor layer 52 which is the insulating layer 42 removed from the lamination structure of the spin injection device 40. In this device 50, the tunnel current is let to flow between the ferromagnetic layer 51 and the semiconductor layer 52 to thereby inject the spins of the ferromagnetic layer 51 into the semiconductor layer 52. In the spin injection device 50, the ferromagnetic layer 51 is formed of a half-metallic ferromagnet which has the electronic structure of the ferromagnetic material as illustrated in FIG. 1.

The fundamental structure of a solid state memory according to the invention will be discussed below referring to FIG. 6.

While the solid state memory of the invention can be realized by an MR device with a multilayer structure comprising the first ferromagnetic layer 21, the insulating layer 22 and the second ferromagnetic layer 23 shown in FIG. 2, it can also be realized by a solid state memory 60 which has a nonmagnetic layer 64 and a third ferromagnetic layer 65 further laminated and has a multilayer structure of first ferromagnetic layer 21/insulating layer 22/second ferromagnetic layer 23/nonmagnetic layer 64/third ferromagnetic layer 65. FIG. 6 is a diagram showing the cross-sectional structure of the solid state memory 60. The lamination of first ferromagnetic layer 21/insulating layer 22/second ferromagnetic layer 23 forms a tunnel junction, and the magnetization direction of the second ferromagnetic layer 23 is controlled by letting the tunnel current flow between the first ferromagnetic layer 21 and the second ferromagnetic layer 23 via the insulating layer 22. The lamination of nonmagnetic layer 64/third ferromagnetic layer 65 forms a CPP-GMR junction and the magnetization direction of the second ferromagnetic layer 23 is detected by letting the current flow between the second ferromagnetic layer 23 and the third ferromagnetic layer 65 via the nonmagnetic layer 64. That is, the writing operation is carried out by letting the tunnel current flow between the first ferromagnetic layer 21 and the second ferromagnetic layer 23 and the reading operation is carried out by detecting the current flowing between the second ferromagnetic layer 23 and the third ferromagnetic layer 65. In the device 60, the first ferromagnetic layer 21 and the third ferromagnetic layer 65 are pin layers and the second ferromagnetic layer 23 is a free layer. In the solid state memory, the first ferromagnetic layer 21 and the second ferromagnetic layer 23 are formed of a half-metallic ferromagnet which has the electronic structure of the ferromagnetic material as illustrated in FIG. 1.

Examples of application of the above-described devices according to the invention to a magnetic head or a magnetic sensor and a solid state memory will be described below.

(Application to Magnetic Head or Magnetic Sensor)

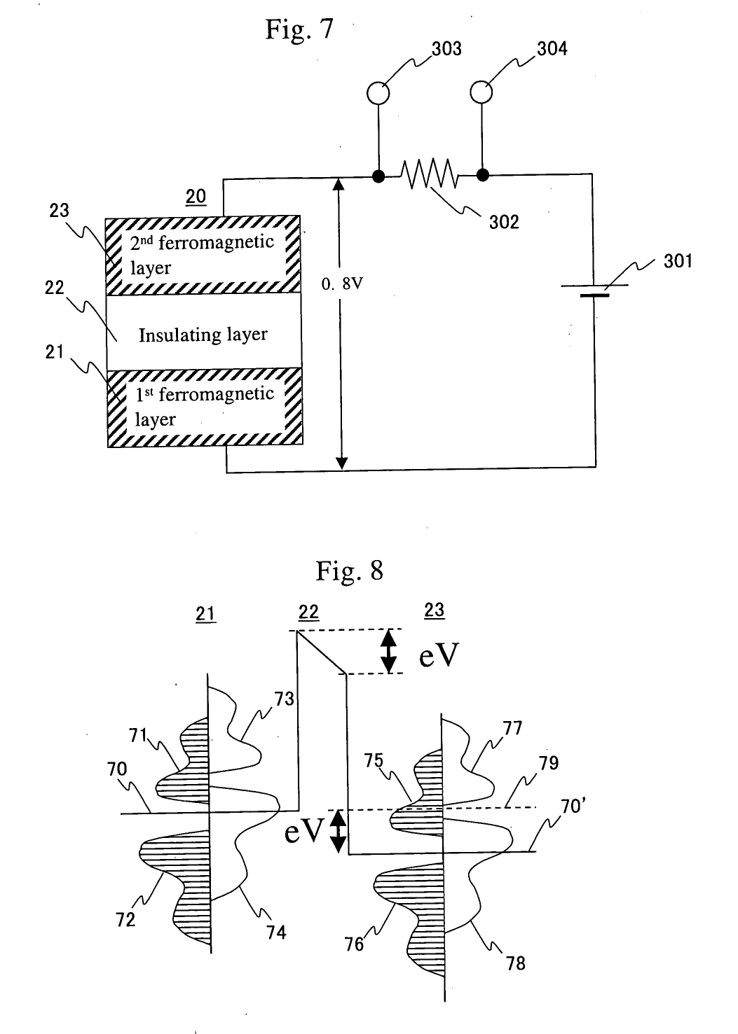

FIG. 7 is a diagram exemplarily illustrating a circuit structure to be adapted to a magnetic head or a magnetic sensor. Hereinafter, the term “magnetic head” is used instead of the tiresome expression of “magnetic head or magnetic sensor”. A power supply 301 is provided to apply a proper external voltage V, 0.8 V in this example, to the MR device 20 shown in FIG. 2. A proper resistor 302 is inserted between the power supply 301 and the MR device 20 so that the current flowing in the MR device 20 can be detected between terminals 303 and 304. A magnetic signal to be detected is located near the MR device 20.

FIG. 8 is a diagram exemplarily showing the density of states of the first ferromagnetic layer 21, the insulating layer 22 and the second ferromagnetic layer 23 of the MR device 20 in case where the magnetizations of the first and second ferromagnetic layers 21 and 23 are parallel to each other. FIG. 8 illustrates the case where both the first and second ferromagnetic layers 21 and 23 are formed of a half-metallic ferromagnet which has the electronic structure of the ferromagnetic material as illustrated in FIG. 1. FIG. 8 shows FIG. 1 rotated counterclockwise by 90 degrees and with horizontal hatches added to the up spin and showing the down spin in white.

In FIG. 8, at the level of Fermi energy 70, the first ferromagnetic layer 21 has up-spin bands 71 and 72 with a band gap therebetween and has a down-spin band 74 which is metallic. Depending on the applied voltage V, at the level of the Fermi energy 70 (the level of a dotted line 79), the second ferromagnetic layer 23 has an up-spin band 75 which is metallic and has up-spin bands 77 and 78 with a band gap therebetween and has a up-spin band 75 which is metallic. In other words, the applied voltage V is set to the gap level of the down-spin band state of the half-metallic ferromagnet illustrated in FIG. 1. That is, in case where the level of the applied voltage V is set in such a way that the level of the Fermi energy of the density of states with no voltage applied to the second ferromagnetic layer 23, with the level of the Fermi energy of the density of states of the first ferromagnetic layer 21 being a reference, is lowered by 1 eV, the current does not flow when the magnetizations of the first and second ferromagnetic layers are parallel to each other.

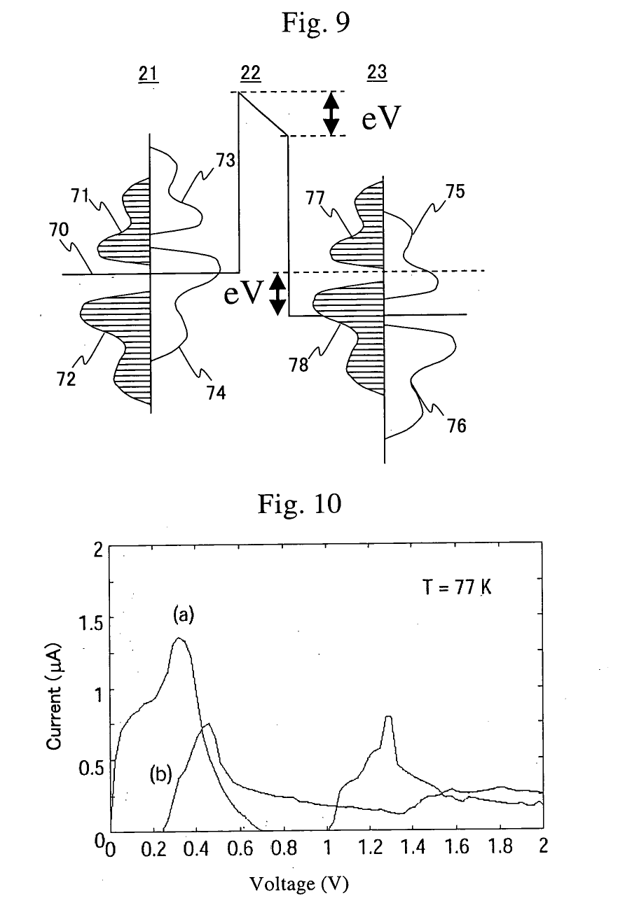

FIG. 9 is an exemplary diagram of the density of states corresponding to those in FIG. 8 in case where the magnetizations of the first and second ferromagnetic layers are antiparallel to each other. That is, the magnetization of the first ferromagnetic layer 21 stays as shown in FIG. 8 while the magnetization of the second ferromagnetic layer 23 is reversed. In this case, while the density of states of the first ferromagnetic layer 21 are the same as those in FIG. 8, the magnetization of the second ferromagnetic layer 23 is reversed. That is, the parallel up spins' are changed to down spins. As a result, at the level corresponding to the Fermi energy 70 (the dotted line in the diagram), a gap appears only in the up spins of the first and second ferromagnetic layers (between 71 and 72 and between 77 and 78), so that the tunnel current flows through the states of the down spins 74 and 75.

FIG. 10 is a diagram showing a current vs. voltage characteristic obtained in case where the magnetizations of the first and second ferromagnetic layers are antiparallel or parallel to each other. A measuring temperature was 77 K. In the diagram, a curve (a) shows the I-V characteristic in case where after a magnetic field of 12×10⁴ (A/m) (≈0.1500 Oe) is applied to the MR device 20, the magnetic field is removed to set the magnetizations of the two ferromagnetic layers parallel to each other, and a curve (b) shows the I-V characteristic in case where after a magnetic field of 12×10⁴ (A/m) is applied to the MR device 20 in the reverse direction after setting the magnetizations parallel to each other, the magnetic field is removed to set the magnetizations of the two ferromagnetic layers antiparallel to each other. The area where the current hardly flew in the voltage range of 0.6 V to 1 V was observed in the curve (a), whereas the current flowing even in this range was observed in the curve (b). If the circuit is constructed in such a way that a voltage of 0.8 V or so is applied to the MR device 20, therefore, the direction of the magnetic signal located opposite to the MR device 20 can be detected by the presence or absence of the voltage which appears between the terminals 303 and 304.

Paying attention to the voltage range of 0.25 V to 0.7 V in the characteristic (a) in FIG. 10, it is apparent that the MR device 20 has a negative resistance depending on how to use the voltage.

Although the MR device 20 is used in FIG. 7, the same effect is obtained even by the use of the MR device 30 shown in FIG. 30. In this case, the antiferromagnetic layer 31 added makes the magnetization of the first ferromagnetic layer more stable.

Therefore, not only a high MR ratio which is expected in the conventional half-metallic ferromagnet is obtained under the application of a finite voltage, but also the switching characteristic is acquired by the parallel and antiparallel orientations of the magnetizations.

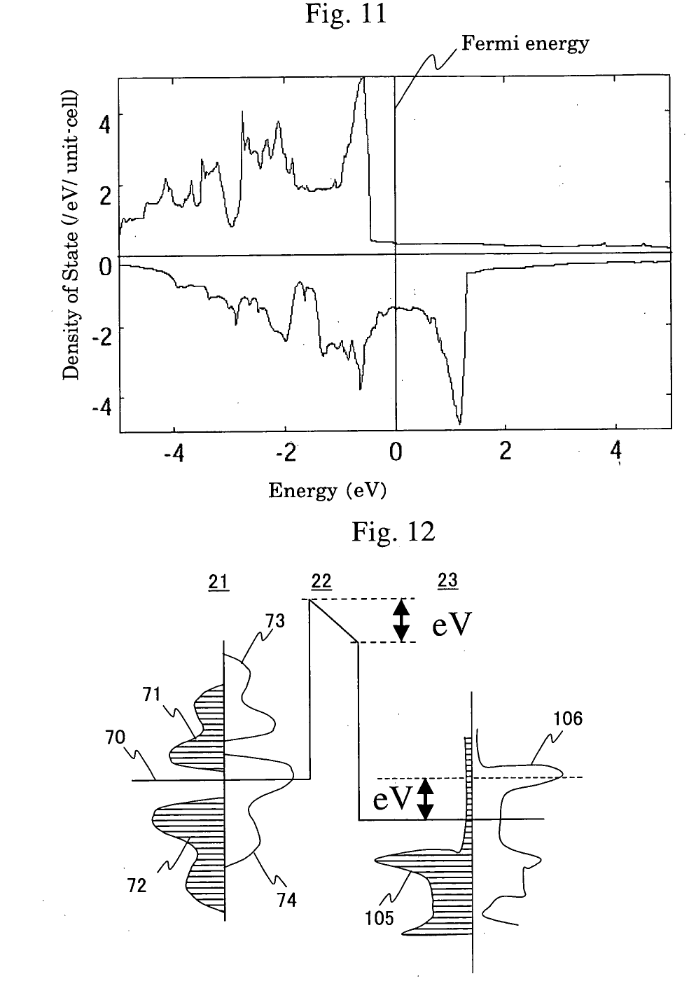

Although the above-described case has been described of the case where both the first and second ferromagnetic layers 21 and 23 are formed of a half-metallic ferromagnet which-has the electronic structure of the ferromagnetic material as illustrated in FIG. 1, the MR devices 20 and 30 shown in FIGS. 2 and 3 may have only one of the first and second ferromagnetic layers being formed of a half-metallic ferromagnet which has the electronic structure of the ferromagnetic material as illustrated in FIG. 1 and the other being a Co base alloy. FIG. 11 is a diagram showing the density of states of Co. In FIG. 11, the peak of the density of states of the down spin is seen near 1 eV and the state of the up spin at that energy level has a small value.

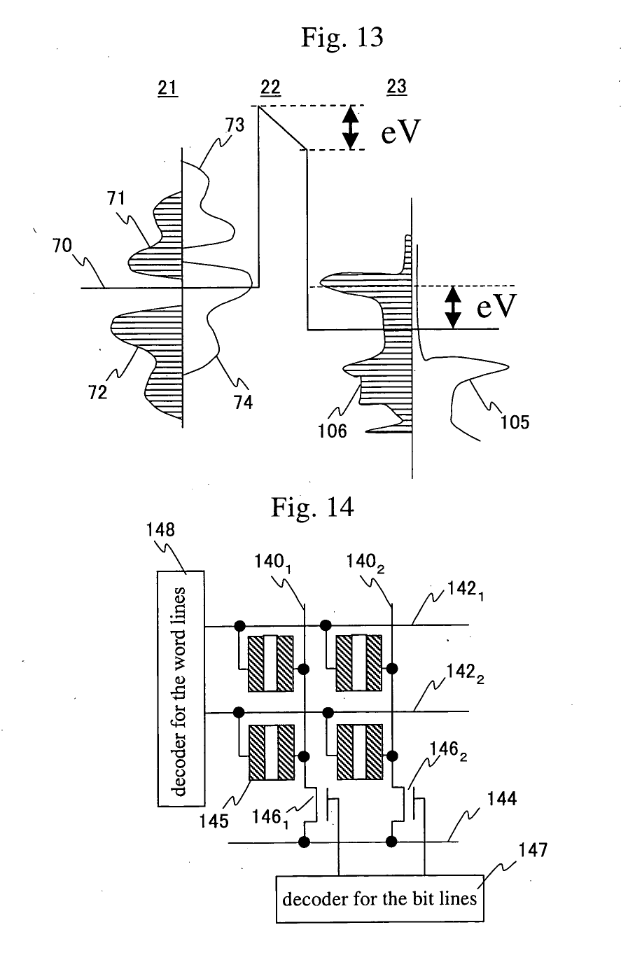

FIGS. 12 and 13 are diagrams showing the densities of states corresponding to those in FIG. 8 and FIG. 9 in case where a Co base alloy is substituted for the second ferromagnetic layer 23. In this case too, FIG. 12 shows the case where the magnetizations of the first and second ferromagnetic layers 21 and 23 are parallel to each other and FIG. 13 shows the case where the magnetizations of the first and second ferromagnetic layers 21 and 23 are antiparallel to each other. As shown in FIG. 12, when the magnetizations of the first and second ferromagnetic layers are parallel to each other and the voltage V is applied, at the level of the Fermi energy 70, the up-spin bands 71 and 72 of the first ferromagnetic layer 21 are separated by the band gap and the down-spin band 74 is metallic. Meanwhile, at the level of the Fermi energy 70 (the dotted line in the diagram), the second ferromagnetic layer 23 has a slight up-spin band 105 and a down-spin band 106 which is metallic. As a result, with the voltage applied, the carriers of the down spins of the bands 74 and 106 carry out electric conduction. In case of the antiparallel orientation as shown in FIG. 13, on the other hand, the same is true of the first ferromagnetic layer 21, but the second ferromagnetic layer 23 is reversed and at the level of the Fermi energy 70 (the dotted line in the diagram), the up-spin band 106 is metallic while the down-spin band 105 is very few. As a result, with the voltage applied, the up-spin state 106 of the second ferromagnetic layer Co does not contribute to electric conduction and the current value becomes small for the slight up-spin state of the second ferromagnetic layer (Co) 23.

As compared with the case where both of the first and second ferromagnetic layers 21 and 23 are formed of a half-metallic ferromagnet which has the electronic structure of the ferromagnetic material as illustrated in FIG. 1, therefore, although the state of the output current is reversed between parallel and antiparallel orientations, the current levels in FIG. 12 and FIG. 13 differ from each other and can be detected distinguishably. While the cases in FIGS. 12 and 13 have a demerit of requiring that a cutoff should be provided in the detection value in order to acquire the switch characteristic as compared with the densities of states in FIGS. 8 and 9, the cases have a merit of improving the sensitivity to an external magnetic field because of a small reversed magnetic field of the Co base alloy.

The following will discuss the results obtained in the case where only the second ferromagnetic layer is formed of a half-metallic ferromagnet which has the electronic structure of the ferromagnetic material as illustrated in FIG. 1 and the other is a Co base alloy. The measuring temperature was 77 K. When the voltage in the tunnel junction was set to 0.05 V, a maximum TMR ratio of 180% was observed for the magnetic field of 4×10⁴ (A/m) (≈500 Oe). When the voltage in the tunnel junction was set to 1.00 V and similar measurement was taken, a maximum TMR ratio of 120% was observed. Therefore, even this case can realize an MR device similar to the one obtained in the case where both of the first and second ferromagnetic layers 21 and 23 are formed of a half-metallic ferromagnet which has the electronic structure of the ferromagnetic material as illustrated in FIG. 1.

(First Application to Solid State Memory)

Next, an example of a solid state memory to which the MR device shown in FIG. 2 or FIG. 3 is used will be discussed. FIG. 14 shows a solid state memory in case where MR devices 20 shown in FIG. 2 are laid out in two rows by two columns 2 as one example of the X-Y matrix. In FIG. 14, MR devices 145 illustrated in FIG. 2 are placed at the intersections of a bit line ¹⁴⁰, and bit line 140₂ and a word line 142₁ and word line 142₂. Reference numeral “147” denotes a decoder 147 for the bit lines and reference numeral “148” denotes a decoder for the word lines. In association with designation of write and read addresses, one of the bit lines and one of the word lines are selected by the decoders 147 and 148 and the voltage is applied to the associated MR device 145. The bit lines are selectively connected to a data line 144 by opening or closing of the gate of a MOS-FET 146.

The MR device 145 is laid out at the intersection of each word line and each bit line, so that only when currents flow in the word line and bit line, the magnetization of just the free layer of the MR device 145 is reversed by a magnetic field which is generated by the sum of both currents. The magnetization of the fixed layer is fixed. The magnetization of the fixed layer is fixed by making the free layer and fixed layer different from each other in thickness in case of FIG. 2, or using the antiferromagnetic layer as shown in FIG. 3.

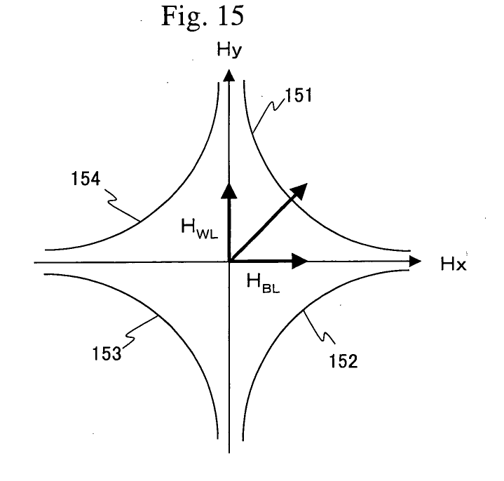

FIG. 15 is a diagram for explaining how the magnetization of the MR device located at a position where currents flow to both a word line and a bit line is reversed (written by a magnetic field) by a magnetic field generated by the sum of both currents. In FIG. 15, H_{BL} indicates the magnetization force generated by the current flowing in a bit line and H_{WL} indicates the magnetization force generated by the current flowing in a word line. While either magnetization force H_{WL} or magnetization force H_{BL} acts on the MR device 145 located adjacent to any word line or bit line, writing in the MR device 145 is done by magnetization when the MR device 145 is located at such a position where both magnetization forces act on the MR device because one of the magnetization forces act on the MR device alone cannot exceed threshold values 151 to 154.

With regard to reading, written data can be known because the voltage on the data line 144 changes depending on whether the current flows to the MR device 145 located at the intersection of the selected word line and bit line or not. In case where the free layer and the fixed layer of the MR device are both formed of a half-metallic ferromagnet which has the electronic structure of the ferromagnetic material as illustrated in FIG. 1, the switching characteristic is provided depending on the direction of the magnetization of the free layer as described in the foregoing description referring to FIG. 10. This structure therefore has merits of ensuring non-destruction reading and making it unnecessary to associate a single MOS-FET with a single MR device as required in the prior art MRAM. As the switching operation of the MR device can take the resistance itself as an output at the time of reading, it is unnecessary to let the pulse current flow to the word lines as needed in the prior art.

In case where the fixed layer of the MR device 145 is formed of a half-metallic ferromagnet which has the electronic structure of the ferromagnetic material as illustrated in FIG. 1 and the free layer is formed of a Co base alloy, the switching characteristic is not provided as described in the foregoing description referring to FIGS. 11 to 13. Even in this case, because the value of the magnetoresistance effect itself is large, providing a cutoff in the output at the time of reading can make the resistance itself as an output.

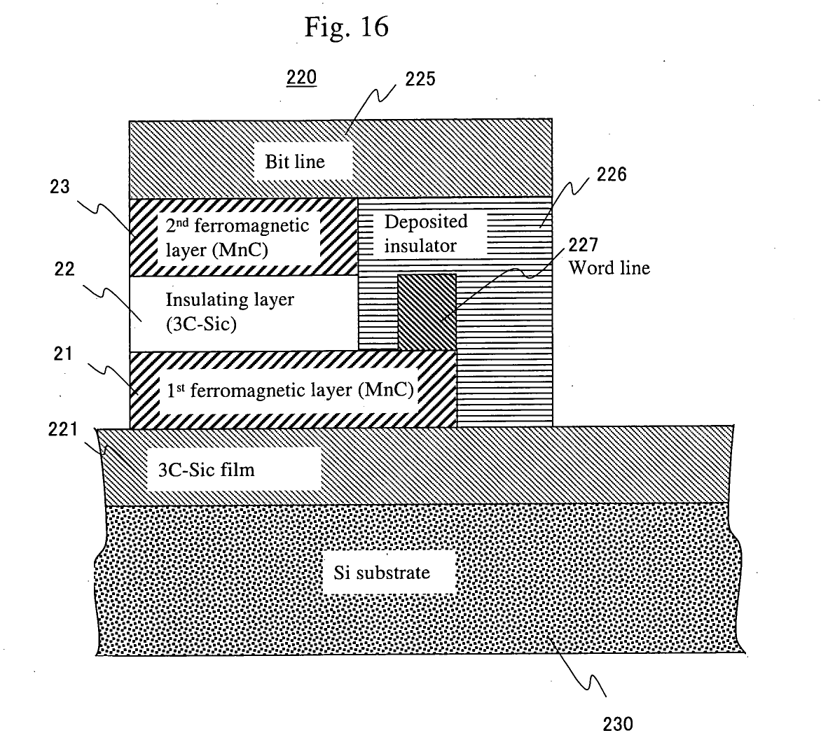

FIG. 16 is an exemplary diagram showing an example in which a solid state memory using the MR devices shown in FIG. 2 is mounted on a silicon substrate for a single memory device 220. After an underlayer 3C—SiC 221 is formed evenly on the top surface of a silicon substrate 230, the layer of memory devices each comprising the first ferromagnetic layer 21 of MnC, the second ferromagnetic layer 22 of 3C—SiC and the second ferromagnetic layer 23 of MnC is formed. Then, the individual memory devices are separated in an X-Y matrix form by lithography technology which is normally used in the field of semiconductors, and word lines 227 are formed on the first ferromagnetic layer 21 in a direction perpendicular to the sheet of the drawing. Then, the areas around the word lines 227 are buried with a deposited insulator 226 so that the areas become level with the second ferromagnetic layer 23. Then, bit lines 225 are formed. Although FIG. 16 shows only one memory device, those memory devices are formed on the Si substrate 230 in an X-Y matrix form.

As apparent from the diagram, when the currents flow to the bit line 225 and word line 227 at the same time, a magnetic field exceeding the threshold value acts on the memory device 220 so that the second ferromagnetic layer 23 or the free layer reverses its magnetization or keeps the original magnetization state as discussed above referring to FIG. 15.

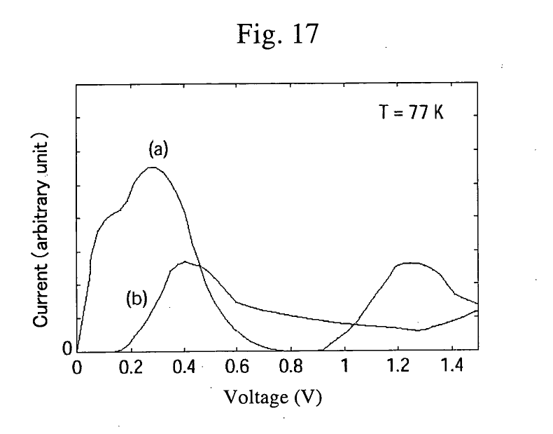

FIG. 17 is a diagram showing a current vs. voltage characteristic of the memory 220 formed as shown in FIG. 16. The measuring temperature was 77 K. In the diagram, a curve (a) shows the I-V characteristic in case where after a magnetic field of 12×10⁴ (A/m) is applied to the MR device 20, the magnetic field is removed to set the magnetizations of the two ferromagnetic layers 21 and 23 parallel to each other, and a curve (b) shows the I-V characteristic in case where after a magnetic field of 12×10⁴ (A/m) is applied to the MR device 20 in the reverse direction, the magnetic field is removed to set the magnetizations of the two ferromagnetic layers antiparallel to each other. It was observed in the curve (a) that the current hardly flew near the voltage of 0.8 V, whereas the current flowing even in this range was observed in the curve (b). If the circuit is constructed in such a way that a voltage of 0.8 V or so is applied to the MR device 20 at the time of reading, therefore, the writing state of the memory device 220 can be detected by the presence or absence of the voltage which appears on the data line 144.

Paying attention to the voltage range of 0.25 V to 0.7 V in the characteristic (a) in FIG. 17, it is apparent that the MR device 20 in this usage also has a negative resistance.

(Second Application to Solid State Memory)

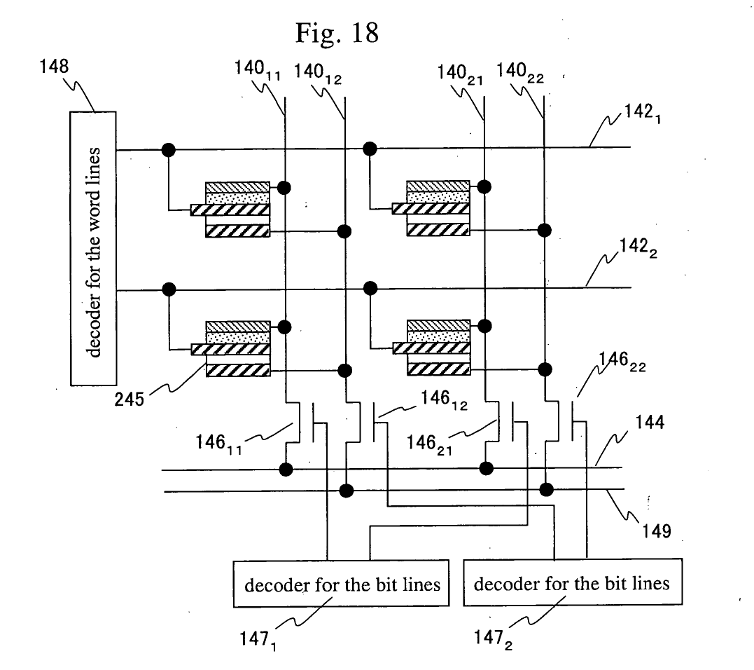

Next, an example of a solid state memory to which the MR device shown in FIG. 6 is used will be discussed. FIG. 18 shows a solid state memory, like the solid state memory shown in FIG. 14, in case where MR devices 60 shown in FIG. 6 are laid out in two rows by two columns 2 as one example of the X-Y matrix. In FIG. 16, while the word line 142₁ and word line 142₂ are the same as those of the solid state memory shown in FIG. 14, two bit lines are provided for a single MR device 60. That is, bit line 140₁₁ and bit line 140₁₂ are provided for one MR device and bit line 140₂₁ and bit line 140₂₂ are provided for another MR device. In this example, an MR device 245 as shown in FIG. 6 is placed at the intersection of a word line and a bit line. Although reference symbols for the individual layers of the MR device 245 are omitted to avoid making the diagram complicated, the layers are shown in the same order as shown in FIG. 6. The second ferromagnetic layer 23 in the middle is shown sticking out from the level of the other layers to make the wiring easier to see. Because two bit lines are provided for a single MR device 60, a decoder 147₁ for the writing bit lines 140₁₁ and 140₂₁ and a decoder 147₂ for the reading bit lines 140₁₂ and 140₂₂ are separately provided. The decoder 148 for the word lines is the same as that of the solid state memory shown in FIG. 14. Reference numeral “149” denotes a power supply line. The voltage is applied to the MR device 245 via the power supply line 149 and a bit line 140 selected through one of the bit lines and one of the word lines selected in association with designation of write and read addresses by the decoders 147 and 148 and the voltage is applied to the associated MR device 145. The bit lines are selectively connected to the data line 144 and power supply line 149 by opening or closing of the gate of the MOS-FET 146.

The MR device 245 is laid out at the intersection of each word line and each bit line, and a voltage to be applied between, for example, the word line 142, and the bit line 140₁₂ selectively connected to the power supply line 149 causes the tunnel current to flow between the first ferromagnetic layer 21 and the second ferromagnetic layer 23 to thereby control the direction of the magnetization of the second ferromagnetic layer 23. That is, in the solid state memory using the MR device shown in FIG. 6, writing is done by letting the tunnel current flow. Reading is done by the current that flows between the first ferromagnetic layer 21 and the second ferromagnetic layer 23 as the voltage is applied between, for example, the word line 142₁ and the bit line 140₁₁ selectively connected to the data line 144.

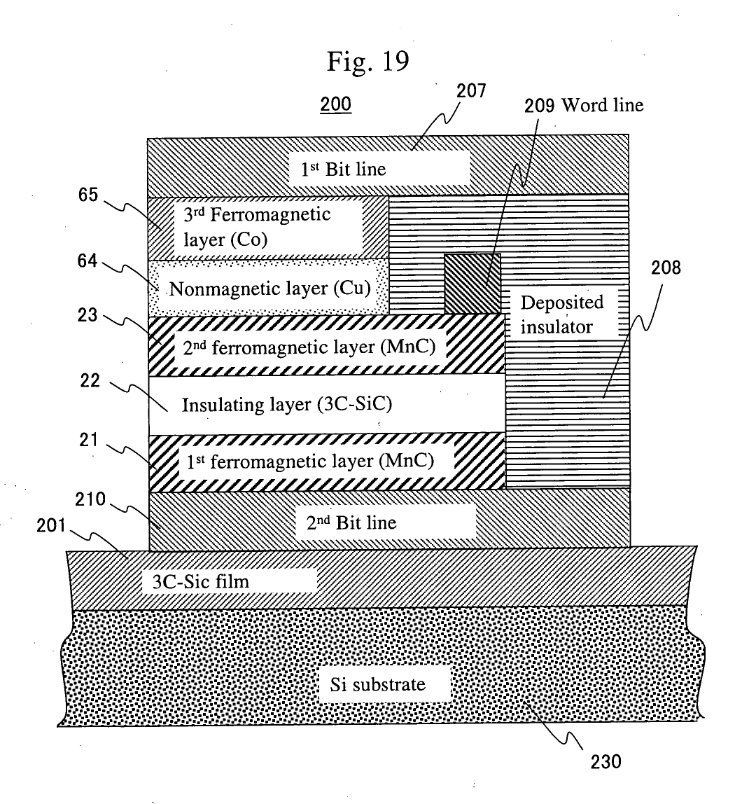

FIG. 19 is an exemplary diagram illustrating an example in which a solid state memory using MR devices shown in FIG. 6 is mounted on a silicon substrate for a single memory device 220. In this example, the nonmagnetic layer 64 is of Cu and the third ferromagnetic layer 65 is of Co.

After the uniform formation of an underlayer 3C—SiC 201 on the top surface of the Si substrate 230, a second bit line 210 (which is indicated by reference symbols 140₂₁ and 140₂₂ in FIG. 18) is patterned in a direction parallel to the sheet of the drawing in association with the layout density of predetermined memory devices. In this case, the second bit line 210 should preferable be of Al. Next, the layer of memory devices each comprising the first ferromagnetic layer 21 of MnC, the second ferromagnetic layer 22 of 3C—SiC, the second ferromagnetic layer 23 of MnC, the nonmagnetic layer 64 of Cu and the third ferromagnetic layer 65 of Co is formed. Then, the individual memory devices are separated in an X-Y matrix form by lithography technology which is normally used in the field of semiconductors, and word lines 209 are formed on the second ferromagnetic layer 23 in a direction perpendicular to the sheet of the drawing. Then, the areas around the word lines 209 are buried with a deposited insulator 208 so that the areas become level with the third ferromagnetic layer 65. Then, bit lines 207 are formed. Although FIG. 19 shows only one memory device 200, those memory devices are formed on the Si substrate 230 in an X-Y matrix form.

As apparent from the diagram, as the voltage is applied to the second bit line 210 and the word line 209, the tunnel current flows via the insulating layer 22. The level of the current flowing in the nonmagnetic layer 64 between the bit line 207 and the word line 209 in accordance with the direction of the magnetization of the second ferromagnetic layer 23 which is controlled by the tunnel current and the change in current level is detected as data written in the memory device 200.

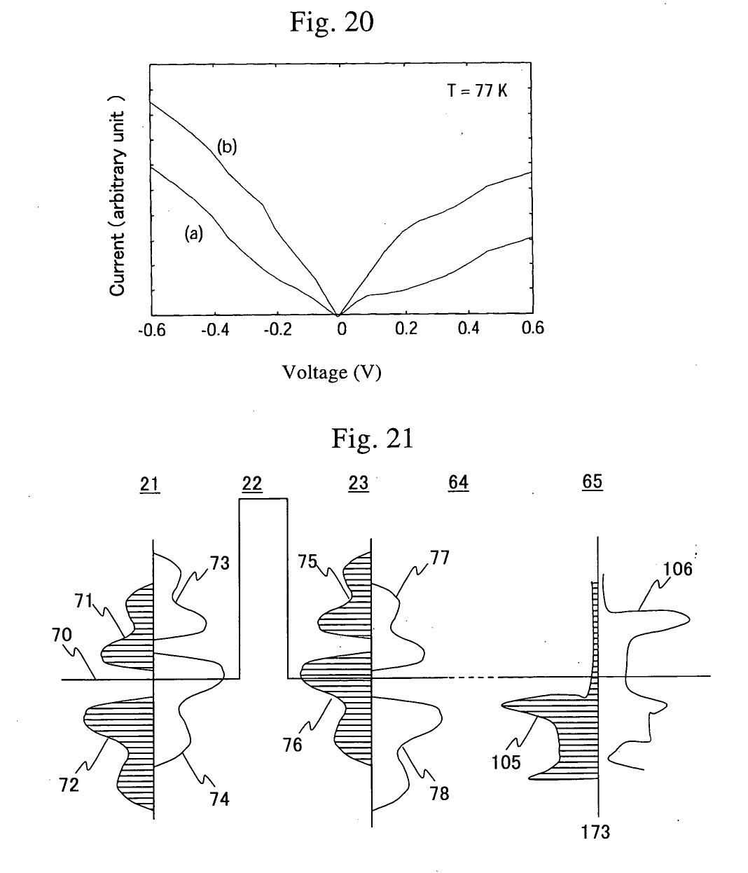

FIG. 20 is a diagram showing a current vs. voltage characteristic between the second ferromagnetic layer MnC 23 and the third ferromagnetic layer Co 65 of the solid state memory shown in FIG. 19. The measuring temperature was 77 K. A curve (a) in the diagram shows the I-V characteristic in case where a current is not let to flow in the tunnel junction device comprising the first and second ferromagnetic layers MnC (parallel magnetization) and a curve (b) shows the I-V characteristic after a current of 10 nA is let to flow in the tunnel junction device (antiparallel magnetization). It is seen from the curves (a) and (b) that the resistance ratio of the CPP-GMR junction portion (the layer comprising the ferromagnetic layer MnC 23-nonmagnetic layer Cu 64-third ferromagnetic layer Co 65) reaches 10%. Further, when the current in the reverse direction flew in the tunnel junction comprising the first ferromagnetic layer MnC 21-insulating layer 22-second ferromagnetic layer MnC 23, the curve (a) in the diagram was observed and the characteristic reversibly changes between the curves (a) and (b) in the diagrams flowing in the tunnel junction device. Because this characteristic is not the switching characteristic, it is necessary to discriminate written data by providing a threshold value. If the voltage between, for example, the second ferromagnetic layer MnC 23 and the third ferromagnetic layer Co 65 is set to 0.4 V, however, signals are obtained with a current of the adequate level and a high resistance ratio is obtained, so that the memory has a good characteristic.

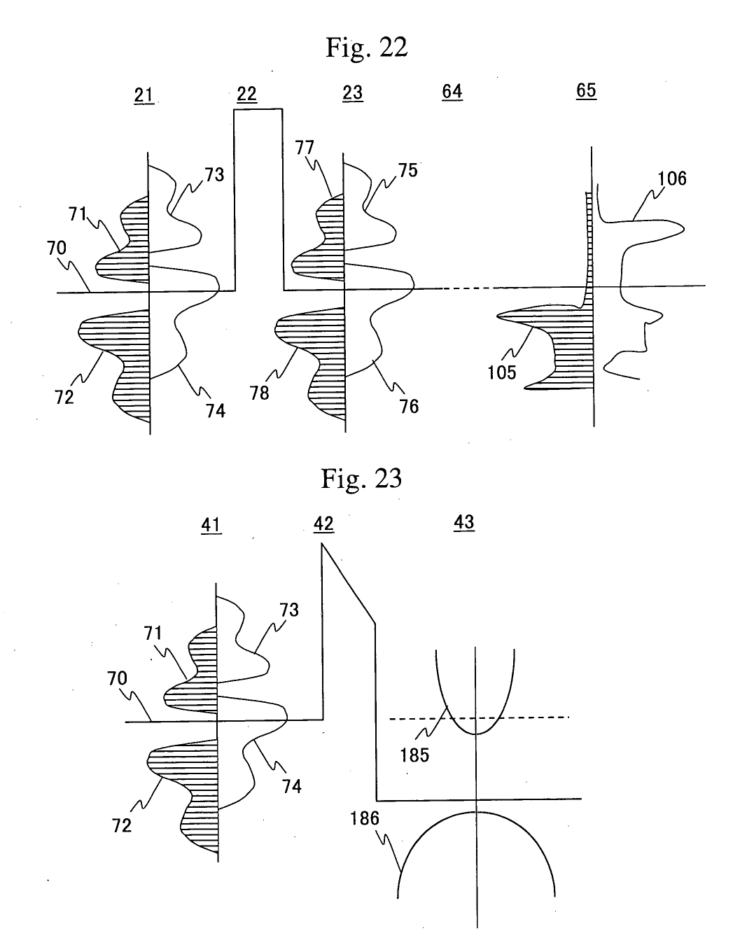

FIGS. 21 and 22 are exemplary diagrams of the densities of states of a memory device in case where the magnetizations of the first ferromagnetic layer MnC 21 and the second ferromagnetic layer MnC 23 of the solid state memory shown in FIG. 19 are antiparallel to each other. The I-V characteristic will be discussed below referring to the densities of states.

In FIG. 21, the up spins 71 and 72 of the first ferromagnetic layer 21 have a gap at the level of the Fermi energy 70 and the down spin 74 is metallic. As the second ferromagnetic layer 23 has an antiparallel magnetization, the up spin 76 is metallic at the level of the Fermi energy 70 and the down spins 77 and 78 have a gap 74. The third ferromagnetic layer (Co) 65 provided via the nonmagnetic layer 64 has an up spin 105 of an extremely small value and a relatively large down spin 106. Therefore, the up spin 76 of the second ferromagnetic layer 23 and the small up spin 105 of the third ferromagnetic layer (Co) 65 contribute to electric conduction, though small the value of the conduction is. This corresponds to a characteristic (a) in FIG. 20.

In FIG. 22, as the first ferromagnetic layer 21 and the second ferromagnetic layer 23 have parallel magnetizations, the up spins 71, 72 and the up spins 77, 78 both have gaps at the level of the Fermi energy 70. By way of contrast, the down spin 74 and down spin 76 are both metallic. The third ferromagnetic layer (Co) 65 provided via the nonmagnetic layer 64 has the up spin 105 of an extremely small value and a relatively large down spin 106. Therefore, the down spin 76 of the second ferromagnetic layer 23 and the relatively large down spin 106 of the third ferromagnetic layer (Co) 65 contribute to electric conduction. Therefore, the current that flows in this case is larger than the current in the case of antiparallel magnetization, and this phenomenon corresponds to the characteristic (b) in FIG. 20.

The writing operation of the solid state memory shown in FIG. 19 is controlled by the tunnel current flowing to the second ferromagnetic layer 23 from the first ferromagnetic layer 21 and data is read by the level of the current flowing to the third ferromagnetic layer (Co) 65 from the second ferromagnetic layer 23. This solid state memory therefore becomes a solid state magnetic memory which functions without using a leak magnetic field generated by the current.

(Spin Injection Device)

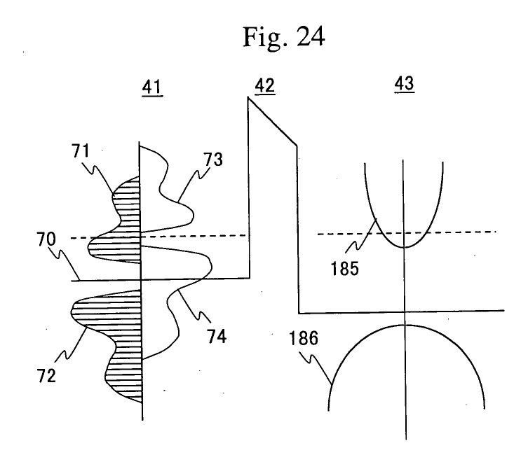

Next, the basic operation of the spin injection device according to the invention will be described referring to exemplary diagrams of the densities of states shown in FIGS. 23 and 24. FIG. 23 exemplarily shows the density of states of the ferromagnetic layer 41, the insulating layer 42 and the semiconductor layer 43 in case where an external voltage is applied to the spin injection device shown in FIG. 4. In FIG. 23, this is the Fermi level at the position of a gap between the up-spin bands 71 and 72 of the ferromagnetic layer 41 and only the down spin 74 contributes to electric conduction to a conduction band 185 of the semiconductor layer 43. Here, the line indicated by the solid line in the density of states of the semiconductor layer 43 is the Fermi level of the semiconductor layer 43. Reference numeral “186” indicates a valence band. As shown in FIG. 24, only the up spin can be injected into the semiconductor layer by applying the external voltage in such a way that the level indicated by the broken line for the bus line 41 is positioned in the area of the valence band 185 of the semiconductor layer 43. That is, the spin polarization to be injected into the semiconductor layer 43 can be changed by merely shifting the Fermi level by controlling the level of the applied voltage.

The optical effects of the spin injection device shown in FIG. 4 were evaluated based on light reflected when light was irradiated onto the spin injection device. With a magnetic field of 1.6×10⁴ (A/m) (≈200 Oe) applied to the prepared spin injection device, polarization was given by a λ/4 plate and linear polarizer and the reflected light was condensed to a sensor using Ge and InAlGaAs photocells to measure the electroluminescence. The measuring temperature was 4.2 K. As are result, the spin polarizability was defined by P=(I₊−I₋)/(I₊+I₋) where I₊ and I₋ were light intensities in positive and negative magnetic fields respectively, and the measured spin polarizability had a maximum value of 5.3%.

With the material for the ferromagnetic layer 41 in FIG. 4 changed to CoFe from MnC, similar evaluation was conducted, resulting in the observation of a maximum spin polarizability of 2.1%.

The spin injection device or the solid state memory can be realized in the following forms.

(1) A spin injection device that is an MR device with lamination of ferromagnetic layer/semiconductor layer, and has a multilayer structure in which the ferromagnetic layer is a half-metallic ferromagnet formed of a material having such an electronic structure that one spin having a metallic band near Fermi energy has a gap at a level of higher energy than the Fermi energy and the other spin has a metallic band at the same level.

(2) A magnetoresistance device with a multilayer structure which has a ferromagnetic tunnel junction formed by lamination of first ferromagnetic layer/insulating layer/second ferromagnetic layer/nonmagnetic layer/third ferromagnetic layer, and in which the first and second ferromagnetic layers are a half-metallic ferromagnet formed of a material having such an electronic structure that one spin having a metallic band near Fermi energy has a gap at a level of higher energy than the Fermi energy, the other spin has a metallic band at the same level and the third ferromagnetic layer has a multilayer structure comprised of a Co base alloy.

As described in detail above, a magnetic head, a solid state memory and a spin injection device with excellent characteristics can be realized by the MR device according to the invention which has a tunnel junction and uses a half-metallic ferromagnet.

1. A magnetoresistance device with a multilayer structure which has a ferromagnetic tunnel junction formed by lamination of a first ferromagnetic layer, an insulating layer and a second ferromagnetic layer, and in which at least one of said first and second ferromagnetic layers is a half-metallic ferromagnet formed of a material having such an electronic structure that one spin having a metallic band near Fermi energy has a gap at a level of higher energy than said Fermi energy and the other spin has a metallic band at the same level.

2. A magnetoresistance device with a multilayer structure which has a ferromagnetic tunnel junction formed by lamination of an antiferromagnetic layer, a first ferromagnetic layer, an insulating layer and a second ferromagnetic layer, and in which at least one of said first and second ferromagnetic layers is a half-metallic ferromagnet formed of a material having such an electronic structure that one spin having a metallic band near Fermi energy has a gap at a level of higher energy than said Fermi energy and the other spin has a metallic band at the same level.

3. A magnetoresistance device with a multilayer structure which has a ferromagnetic tunnel junction formed by lamination of a ferromagnetic layer, an insulating layer and a semiconductor layer, and in which said ferromagnetic layer is a half-metallic ferromagnet formed of a material having such an electronic structure that one spin having a metallic band near Fermi energy has a gap at a level of higher energy than said Fermi energy and the other spin has a metallic band at the same level.

4. A magnetic head comprising a magnetoresistance device with a multilayer structure which has a ferromagnetic tunnel junction formed by lamination of a first ferromagnetic layer, an insulating layer and a second ferromagnetic layer, and in which at least one of said first and second ferromagnetic layers is a half-metallic ferromagnet formed of a material having such an electronic structure that one spin having a metallic band near Fermi energy has a gap at a level of higher energy than said Fermi energy and the other spin has a metallic band at the same level.

5. A magnetic sensor comprising a magnetoresistance device with a multilayer structure which has a ferromagnetic tunnel junction formed by lamination of a first ferromagnetic layer, an insulating layer and a second ferromagnetic layer, and in which at least one of said first and second ferromagnetic layers is a half-metallic ferromagnet formed of a material having such an electronic structure that one spin having a metallic band near Fermi energy has a gap at a level of higher energy than said Fermi energy and the other spin has a metallic band at the same level.

6. A magnetic head comprising a magnetoresistance device with a multilayer structure which has a ferromagnetic tunnel junction formed by lamination of an antiferromagnetic layer, a first ferromagnetic layer, an insulating layer and a second ferromagnetic layer, and in which at least one of said first and second ferromagnetic layers is a half-metallic ferromagnet formed of a material having such an electronic structure that one spin having a metallic band near Fermi energy has a gap at a level of higher energy than said Fermi energy and the other spin has a metallic band at the same level.

7. A magnetic sensor comprising a magnetoresistance device with a multilayer structure which has a ferromagnetic tunnel junction formed by lamination of an antiferromagnetic layer, a first ferromagnetic layer, an insulating layer and a second ferromagnetic layer and in which at least one of said first and second ferromagnetic layers is a half-metallic ferromagnet formed of a material having such an electronic structure that one spin having a metallic band near Fermi energy has a gap at a level of higher energy than said Fermi energy and the other spin has a metallic band at the same level.

8. A solid state memory comprising a magnetoresistance device with a multilayer structure which has a ferromagnetic tunnel junction formed by lamination of a first ferromagnetic layer an insulating layer and a second ferromagnetic layer and in which at least one of said first and second ferromagnetic layers is a half-metallic ferromagnet formed of a material having such an electronic structure that one spin having a metallic band near Fermi energy has a gap at a level of higher energy than said Fermi energy and the other spin has a metallic band at the same level.

9. The magnetoresistance device according to claim 1, wherein said magnetoresistance device has a negative resistance when magnetizations of said first and second ferromagnetic layers are parallel to each other.

10. The magnetoresistance device according to claim 1, wherein said magnetoresistance device has a negative resistance when magnetizations of said first and second ferromagnetic layers are antiparallel to each other.

11. The magnetoresistance device according to claim 1, wherein said first or second ferromagnetic layer is formed of zinc-blende type MnC.

12. The magnetoresistance device according to claim 1, wherein said first or second ferromagnetic layer has a zinc-blende type crystal structure and is formed of an Mn compound.

13. The magnetoresistance device according to claim 1, wherein said first or second ferromagnetic layer has a zinc-blende type crystal structure and has a lattice constant in a range of 4.0 to 4.5 Angstroms.

14. A magnetic head which comprises a magnetoresistance device with a multilayer structure which has a ferromagnetic tunnel junction formed by lamination of a first ferromagnetic layer, an insulating layer and a second ferromagnetic layer, and in which at least one of said first and second ferromagnetic layers is a half-metallic ferromagnet formed of a material having such an electronic structure that one spin having a metallic band near Fermi energy has a gap at a level of higher energy than said Fermi energy and the other spin has a metallic band at the same level wherein said magnetoresistance device has a negative resistance when magnetizations of said first and second ferromagnetic layers are antiparallel to each other and operates under a finite bias indicating a negative resistance area.
